(19) United States
(12) Patent Application Publication
(10) Pub. No.: US 2010/0070980 A1
(43) Pub. Date: Mar. 18, 2010

(54) EVENT DETECTION SYSTEM, EVENT DETECTION METHOD, AND PROGRAM

(75) Inventors: Hideki Tanaka, Kawasaki (JP); Masatomo Yasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/494,804

(22) Filed: Jun. 30, 2009

(30) Foreign Application Priority Data
Sep. 16, 2008 (JP) 2008-236528

(51) Int. Cl. G06F 9/54; G06F 9/455

(52) U.S. Cl. 719/318; 718/1

(57) ABSTRACT

An event detection computer system includes: a plurality of virtual machines for implementing virtual execution environments; an event detection portion for detecting an event that occurred in the virtual execution environments; and an event presentation portion for presenting, when an event occurred in the virtual execution environment not displayed on the display device being detected by the event detection portion, event information concerning the event occurred in the virtual execution environment in a virtual execution environment currently displayed on the display device.

### CROSS-REFERENCE TO RELATED APPLICATION

This application is based upon and claims the benefit of priority of the prior Japanese Patent Application No. 2008-236528, filed on Sep. 16, 2008, the entire contents of which are incorporated herein by reference.

### FIELD

The present invention relates to an event detection system including a plurality of virtual machines that respectively implement virtual execution environments, an event detection method, and a program.

### BACKGROUND

In the field of computer science, rapid progress has been made in virtualization techniques in recent years (see e.g., Japanese Laid-open Patent Publication No. 2003-323306A). Here, the virtualization techniques refer to techniques for concealing physical properties of computer resources from a system, application software, or a user that interacts with the resources. By using the virtualization techniques, it is possible to make a single physical resource look like a plurality of logical resources or a plurality of physical resources look like a single logical resource. Further, it is also possible to make a single physical resource look like a single logical resource with some kind of different properties.

A virtual machine is one of the virtualization techniques as described above. By providing a single computer with a plurality of virtual machines, a plurality of virtual execution environments (e.g., OSes) can be implemented (operated) on the computer, for example. Herein, it is assumed that, for example, a single computer is provided with virtual machines A to C, and the virtual machine A implements an OS-1, the virtual machine B implements an OS-2, and the virtual machine C implements an OS-3. In this case, a user can switch to the OS to be displayed on a display screen of the computer from another using an input device. As a result, the plurality of OSes can be used in accordance with the user's intended purposes, for example, using the OS-1 for a development purpose, the OS-2 for an evaluation purpose, and the OS-3 for a data processing purpose.

### SUMMARY

According to an aspect of the invention, an event detection system accessible to a display device includes: a plurality of virtual machines for respectively implementing virtual execution environments; an event detection portion for detecting an event occurred in the virtual execution environments; and an event presentation portion for presenting, when an event occurred in the virtual execution environment not displayed on the display device being detected by the event detection portion, event information concerning the event occurred in the virtual execution environment in the virtual execution environment currently displayed on the display device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating a schematic configuration of an information processing apparatus according to Embodiment 1 of the present invention.

FIG. 2 is a diagram illustrating respective function blocks implemented in a virtual execution environment 110a.

FIG. 3 is a diagram illustrating one example of detection condition data registered on a condition data table.

FIG. 4 is a diagram illustrating one example of event information recorded on an event information accumulation table.

FIG. 5 is a diagram illustrating one example of correspondence data recorded on a correspondence table.

FIG. 6 is a diagram illustrating one example of event information displayed on a display device.

FIG. 7 is a flow chart illustrating an operation example of the information processing apparatus when a user logged in thereto.

FIG. 8 is a flow chart illustrating an operation example of the information processing apparatus when an event detection portion detects an event of an application software program.

FIG. 9 is a flow chart illustrating an operation example of the information processing apparatus when an event collection and distribution portion collects event information sent from an event communication potion in each virtual execution environment.

FIG. 10 is a flow chart illustrating an operation example of the information processing apparatus when an event communication portion in the virtual execution environment used by the user receives the event information from the event collection and distribution portion.

FIG. 11 is a block diagram illustrating a schematic configuration of an information processing apparatus according to Embodiment 2 of the present invention.

FIG. 12 is a diagram illustrating respective function blocks implemented in a virtual execution environment 140a.

FIG. 13 is a block diagram illustrating a schematic configuration of a communication system according to Embodiment 3 of the present invention.

FIG. 14 is a diagram illustrating respective function blocks implemented in a virtual execution environment 160a.

### DESCRIPTION OF EMBODIMENTS

Conventionally, when an event occurred in one of the OSes (virtual execution environments), the user could have not known that the event occurred unless he or she switched from the OS used by the user at that time to the OS in which the event occurred. For example, it is assumed that the OS currently used by the user is the OS-1, and the occurred event is reception of a message by an instant messenger (IM) present in the OS-3. In this case, the user could have not known that the event occurred in the OS-3 unless he or she switched from the OS-1 to the OS-3. Therefore, regardless of the presence or absence of an occurrence of an event, the user needed to check whether an event had occurred or not by switching the OSes one by one using the input device. This has impaired the convenience and productivity of the user.

According to the event detection computer system of an embodiment of the invention, an event detection portion detects an event that occurred in virtual execution environments. Here, the virtual execution environments are implemented by virtual machines. When an event that occurred in one of the virtual execution environments not displayed on a display device, an event presenting portion presents event information concerning the event that occurred in the virtual execution environment in a virtual execution environment that is actually displayed on the display device at present. Thus, without switching the virtual execution environments, the user can check in real time in the virtual execution environment that is actually displayed on the display device at present that the event occurred in the virtual execution environment that is not displayed on the display device. As a result, it is possible to improve the convenience of the user.

According to an aspect of the invention, an event detection method executed by an event detection computer system accessible to a display device includes: implementing virtual execution environments respectively by a plurality of virtual machines; detecting an event occurred in the virtual execution environments; and presenting, when an event occurred in the virtual execution environment not displayed on the display device being detected in the detection, event information concerning the event occurred in the virtual execution environment in the virtual execution environment currently displayed on the display device.

According to an aspect of the invention, a computer readable recording medium storing a program for causing a computer accessible to a display device to execute: a virtual execution environment implementation process for implementing virtual execution environments; an event detection process for detecting an event occurred in the virtual execution environments; and an event presentation process for presenting, when an event occurred in the virtual execution environment not displayed on the display device being detected in the event detection process, event information concerning the event occurred in the virtual execution environment in the virtual execution environment currently displayed on the display device.

It is noted that the event detection method, the program and computer readable recording medium storing the program of the Embodiment produce the same effects as those produced by the event detection computer system.

As described above, the event detection computer system, the event detection method, and a program of the present invention can improve the convenience and productivity of a user.

In one embodiment of the invention, it is preferable that the event detection computer system is further accessible to an input device, the event information includes at least the event that occurred in the virtual execution environment and identification data for identifying the virtual machine implementing the virtual execution environment in which the event occurred, and the event detection computer system further includes: an event selection portion for receiving an instruction from a user through the input device to select the event information presented in the virtual execution environment currently displayed on the display device; and a virtual execution environment switching portion for switching from the virtual execution environment currently displayed on the display device to the virtual execution environment implemented by the virtual machine indicated by the identification data of the event information corresponding to the selection instruction received by the event selection portion. This allows a user to switch, with ease, to the virtual execution environment in which an event occurred.

In one embodiment of the invention, it is preferable that the event detection computer system is further accessible to an input device, the event detection computer system further includes a condition data entry portion for receiving, from the user through the input device, detection condition data that associates a detection trigger indicting an action at an occurrence of an event in the virtual execution environment with the event, and entering the condition data in a condition data recording portion, and when the action at the occurrence of the event in the virtual execution environment matches the detection trigger indicated by the detection condition data entered in the condition data recording portion, the event detection portion detects that the event associated with the detection trigger occurred in the virtual execution environment. Here, the action at the occurrence of the event in the virtual execution environment is, for example, a start of reproduction of an audio file or display of a pop-up window. This allows presentation of event information desired by a user in the virtual execution environment currently displayed on the display device.

Hereinafter, embodiments of the present invention will be described in detail with reference to the drawings.

### Embodiment 1

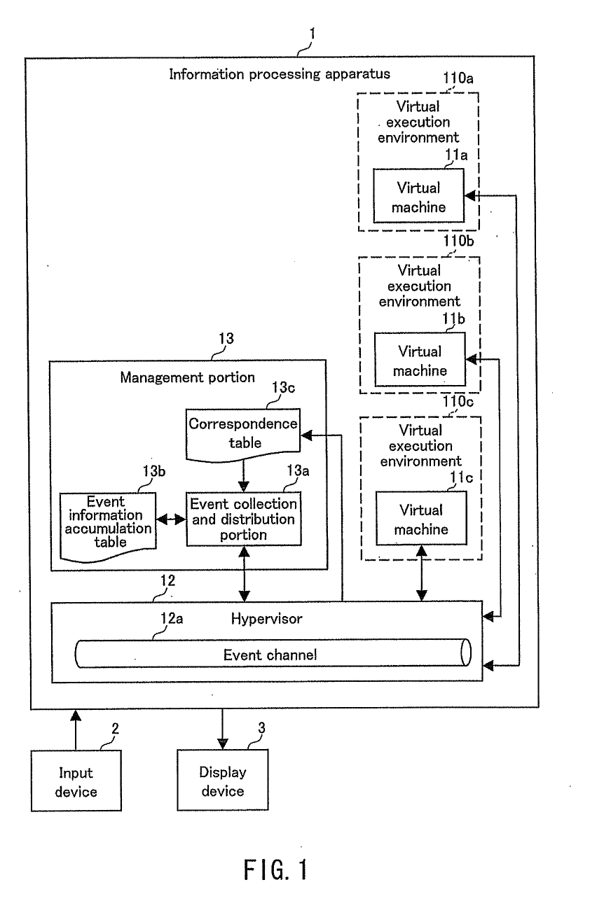

FIG. 1 is a block diagram illustrating a schematic configuration of an information processing apparatus 1 according to the present embodiment. The information processing apparatus (event detection system) 1 illustrated in FIG. 1 is connected to an input device 2 and a display device 3. The information processing apparatus 1 is, for example, a personal computer, a server, a workstation, or the like. The input device 2 is an arbitrary input device, such as a mouse, a keyboard, a remote controller, a touch panel, or a voice recognition device. The display device 3 is an arbitrary display device, such as a liquid crystal display, an organic electroluminescence display, an inorganic electroluminescence display, a plasma display, or a CRT display.

The information processing apparatus 1 includes virtual machines 11a to 11c, a hypervisor 12, and a management portion 13. For the purpose of convenience in explanation, the number of the virtual machines illustrated in FIG. 1 is 3. However, the number is not particularly limited as long as the information processing apparatus 1 includes a plurality of the virtual machines.

The virtual machines 11a to 11c are architectures or software that virtualize resources (a CPU, a memory, etc.) of the information processing apparatus 1 and then implement the virtualized information processing apparatus 1. That is, the virtual machines 11a to 11c are respectively operated to implement (operate) virtual execution environments 110a to 110c in the information processing apparatus 1. In the present embodiment, it is assumed that the virtual execution environments are operating systems (OSes). That is, in the present embodiment, three OSes can be operated on the single information processing apparatus 1.

Furthermore, in the present embodiment, a virtual-machine identification (VM-ID; identification data) is assigned to each of the virtualization machines 11a to 11c so as to uniquely identify the virtual machines. Specifically, the VM-ID “VM-001” is assigned to the virtual machine 11a, the VM-ID “VM-002” is assigned to the virtual machine 11b, and the VM-ID “VM-003” is assigned to the virtual machine 11c.

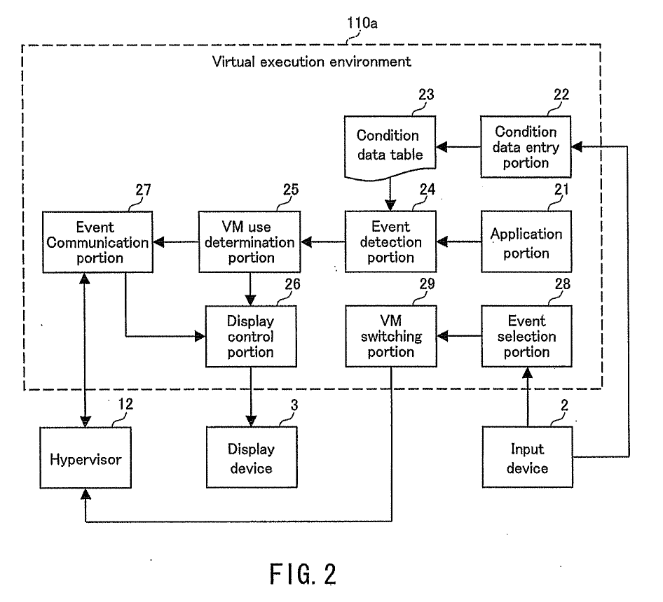

FIG. 2 is a diagram illustrating respective function blocks implemented in the virtual execution environment 110a according to the present embodiment. As illustrated in FIG. 2, the following function blocks are implemented in the virtual execution environment 110a by the virtual machine 11a: an application portion 21, a condition data entry portion 22, a condition data table 23, an event detection portion 24, a VM use determination portion 25, a display control portion 26, an event communication portion 27, an event selection portion 28, and a VM switching portion 29. It is noted that the same function blocks are also implemented in the virtual execution environments 110b and 110c.

Here, a program for implementing the respective functions of the application portion 21, the condition data entry portion 22, the event detection portion 24, the VM use determination portion 25, the display control portion 26, the event communication portion 27, the event selection portion 28, and the VM switching portion 29 on the information processing apparatus 1 or a recording medium in which the program is recorded is also one embodiment of the present invention. Further, the condition data table 23 is embodied by an internal storage device (e.g., RAM, ROM, HDD, etc.) of the information processing apparatus 1 or a storage device that is accessible from the information processing apparatus 1 (e.g., CD, DVD, FD, a server, etc.).

The application portion 21 is performed by one or more application software programs operable in the virtual execution environment 110a. Examples of the application software programs include an IM, a scheduler, a browser, a mailer, a spreadsheet, a word processor, a simulator, a software program for contents development, a software program for engineering, and an educational software program. Here, the types of the software programs are not particularly limited.

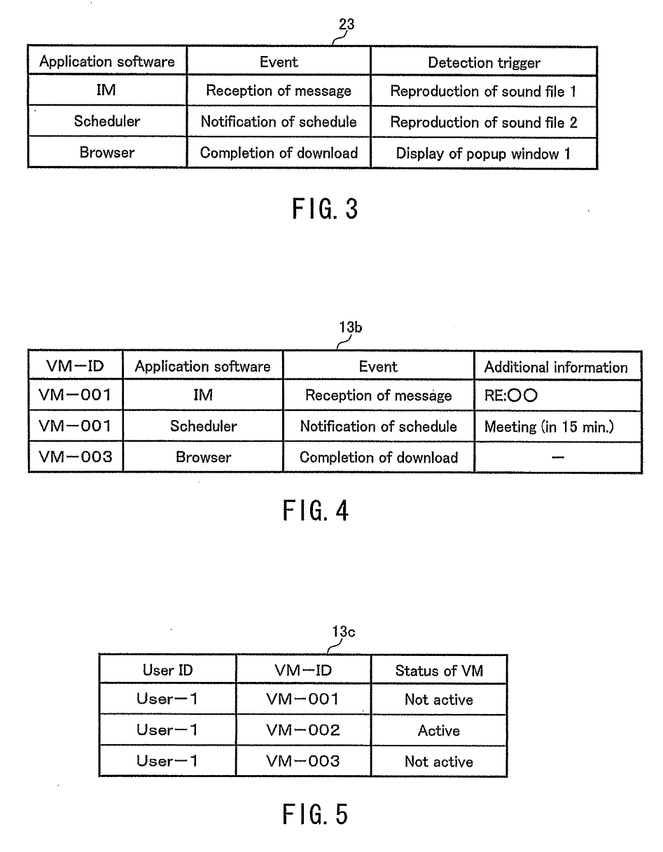

Through the input device 2, the condition data entry portion 22 receives from the user detection condition data containing: detection triggers each indicating an operation of an application software program at an occurrence of an event; and the events. The condition data entry portion 22 enters the received detection condition data in the condition data table (condition data recording portion) 23. FIG. 3 is a diagram illustrating an example of the detection condition data entered in the condition data table 23 according to the present embodiment. As illustrated in FIG. 3, the application software programs, the events, and the detection triggers are entered in the condition data table 23 as the detection condition data.

That is, the first record of the condition data table 23 illustrated in FIG. 3 indicates that when reproduction of a sound file (audio file) 1 starts, it means that a message is received by the IM. Further, the second record of the condition data table 23 indicates that when reproduction of a sound file 2 starts, it means that a schedule is notified by the scheduler. Furthermore, the third record of the condition data table 23 indicates that when a popup window 3 is displayed on the display device 3, it means that download by the browser is completed.

In the present embodiment, as illustrated in FIG. 3, although an example in which the file names are registered in the detection triggers in the condition data table 23 has been described, the configuration is not limited to this example. For example, in place of the file names, identifiers in WAV files or popup windows may be registered in the detection triggers in the condition data table 23.

The event detection portion 24 determines, by monitoring the application portion 21, whether or not an operation of each application software program at an occurrence of an event matches any of the detection triggers recorded in the condition data table 23. When the operation of the application software program at the occurrence of an event matches one of the detection triggers, the event detection portion 24 detects that the event recorded in the condition data table 23 while being corresponded with the detection trigger occurred in the application software program. That is, the event detection portion 24 detects the event that occurred in the application software program.

Further, when the event detection portion 24 detects the event that occurred in the application software program, it extracts additional information on the event from the application software program in which the event occurred. When the application software program is an IM for example, the event detection portion 24 extracts the subject of the received message from the IM as the additional information of the event. Further, when the application software program is a scheduler for example, the event detection portion 24 extracts the details of a schedule from the scheduler as the additional information of the event. Then, the event detection portion 24 generates event information concerning the detected event. Here, the event information contains: the VM-ID of the virtual machine that implements the virtual execution environment in which the application software program with the occurred event operates; the application software program; the event; and the additional information on the event. The event detection portion 24 outputs the generated event information to the VM use determination portion 25.

When the event information is outputted from the event detection portion 24, the VM use determination portion 25 determines whether or not the user is currently using the virtual execution environment (the virtual execution environment 110a in FIG. 2) in which the VM use determination portion 25 is implemented. In other words, the VM use determination portion 25 determines whether or not the user is currently using the virtual execution environment in which the application software program with the occurred event operates. Here, the phrase “the user is currently using the virtual execution environment” refers, for example, to a state in which a virtual execution environment is actually displayed on the display device 3 at present, and the input device 2 is effective on the virtual execution environment displayed on the display device 3.

When the VM use determination portion 25 determines that the user is currently using the virtual execution environment in which the application software program with the occurred event operates, it outputs the event information outputted from the event detection portion 24 to the display control portion 26. In this case, the display control portion 26 causes the display device 3 to display the event information outputted from the VM use determination portion 25. As a result, the user can check in the virtual execution environment he or she currently uses that the event occurred in the application software program. In contrast, when the VM use determination portion 25 determines that the user is not currently using the virtual execution environment in which the application software program with the occurred event operates, it outputs the event information outputted from the event detection portion 24 to the event communication portion 27. In this case, the event communication portion 27 sends the event information outputted from the VM use determination portion 25 to the management portion 13 through the event channel 12a of the hypervisor 12.

The event selection portion 28 receives an instruction to select the event information displayed on the display device 3 from the user through the input device 2. The event selection portion 28 outputs the received selection instruction to the VM switching portion 29.

The VM switching portion 29 instructs the hypervisor 12 to switch from the virtual execution environment currently used by the user to the virtual execution environment implemented by the virtual machine with the VM-ID contained in the event information corresponding to the selection instruction received by the event selection portion 28.

The hypervisor (virtual execution environment switching portion) 12 is a control program that operates at an interlayer placed between the virtual machines 11a to 11c and the hardware, and has the capability of controlling the virtual machines 11a to 11c. Specifically, when the hypervisor 12 is given an instruction from the VM switching portion 29 to switch the virtual execution environments, it switches from the virtual execution environment currently used by the user to the virtual execution environment corresponding to the switching instruction. Although the details will be described later, the hypervisor 12 has the capability of writing correspondence data to or rewriting correspondence data on the correspondence table 13c of the management portion 13. Here, the hypervisor 12 is provided with the event channel 12a. The event channel 12a is a channel that intermediates a data exchange between the virtual execution environments 110a to 110c, which are implemented respectively by the virtual machines 11a to 11c, and the management portion 13.

The management portion 13 includes an event collection and distribution portion 13a, an event information accumulation table 13b, and the correspondence table 13c. Here, functions of the event collection and distribution portion 13a are implemented by an arithmetic unit, such as a CPU provided in the information processing apparatus 1, executing a given program. Therefore, a program for implementing the above functions in the information processing apparatus 1 or a recording medium on which the program is recorded is also one embodiment of the present invention. Further, the event information accumulation table 13b and the correspondence table 13c are embodied by an internal storage device of the information processing apparatus 1 or a storage device that is accessible from the information processing apparatus 1.

The event collection and distribution portion 13a collects the event information sent from the event communication portion 27 implemented in each of the virtual execution environments 110a to 110c. The event collection and distribution portion 13a records the collected event information on the event information accumulation table 13b. FIG. 4 illustrates an example of the event information recorded on the event information accumulation table 13b according to the present embodiment. As illustrated in FIG. 4, the VM-IDs, the application software programs, the events, and the additional information on the events are recorded on the event information accumulation table 13b as the event information.

On the correspondence table 13c, correspondence data indicating the correspondence between a user ID for uniquely identifying a user and the VM-ID assigned to the virtual machine implementing the virtual execution environment that is currently used by the user is recorded. FIG. 5 illustrates an example of the correspondence data recorded on the correspondence table 13c according to the present embodiment. As illustrated in FIG. 5, the user IDs, the VM-IDs, and the statuses of the VMs are recorded on the correspondence table 13c as the correspondence data. In the present embodiment, account information that is provided when logging into the information processing apparatus 1 is used as the user IDs. Further, as the statuses of the VMs, either active or not active is recorded. Being active refers to a state in which the user is currently using a virtual execution environment implemented by one of the virtual machines. Being not active refers to a state in which the user is not currently using a virtual execution environment implemented by one of the virtual machines.

That is, the correspondence table 13c illustrated in FIG. 5 indicates that a user with the user ID “User-1” is currently using the virtual execution environment 110b implemented by the virtual machine 11b with the VM-ID “VM-002”. Specifically the virtual execution environment 110b is actually displayed on the display device 3 at present, and the input device 2 is effective on the virtual execution environment 110b displayed on the display device 3. In other words, the correspondence table 13c illustrates that the user with the user ID “User-1” is not currently using the virtual execution environment 110a implemented by the virtual machine 11a with the VM-ID “VM-001” or the virtual execution environment 110c implemented by the virtual machine 11c with the VM-ID “VM-003”.

The event collection and distribution portion 13a sends the event information recorded on the event information accumulation table 13b to the event communication portion 27 in the virtual execution environment implemented by the virtual machine with the VM-ID that corresponds to “active” in the statuses of the VMs on the correspondence table 13c. That is, in the present embodiment, the event collection and distribution portion 13a sends the event information recorded on the event information accumulation table 13b illustrated in FIG. 4 to the event communication portion 27 in the virtual execution environment 110b implemented by the virtual machine 11b with the VM-ID “VM-002”. The event communication portion 27 in the virtual execution environment 110b receives the event information sent from the event collection and distribution portion 13a, and outputs the received event information to the display control portion 26. The display control portion 26 causes the display device 3 to display the event information outputted from the event communication portion 27.

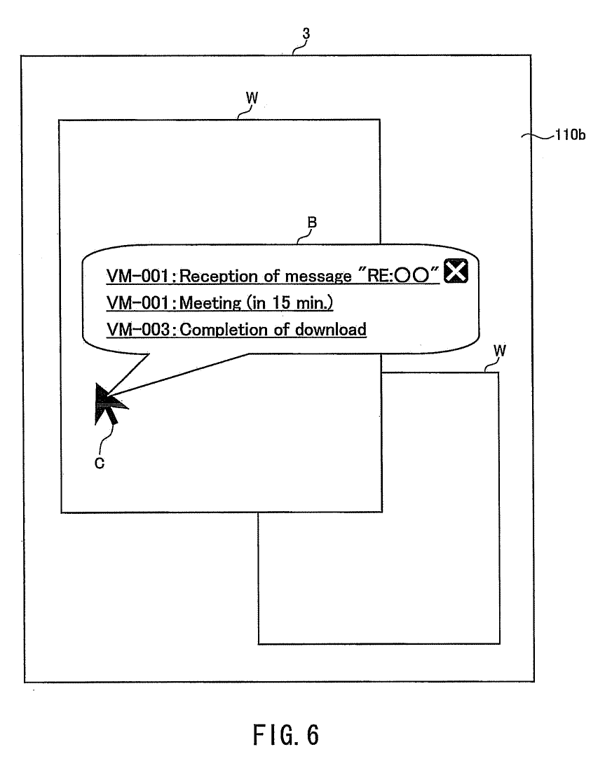

FIG. 6 is a diagram illustrating an example of the event information displayed on the display device 3. As illustrated in FIG. 6, the virtual execution environment 110b currently used by the user is displayed on the display device 3. Further, in the virtual execution environment 110b, an arbitrary window W, a mouse cursor C, and a balloon window B capable of following the mouse cursor C are displayed. Here, as illustrated in FIG. 6, the event information is indicated in the balloon window B. Thus, without switching the virtual execution environments, the user can check in the virtual execution environment he or she currently uses (in this case, the virtual execution environment 110b) that events occurred in the virtual execution environments that are not currently used by the user (in this case, the virtual execution environments 110a and 110c). It is noted that the embodiment illustrated in FIG. 6 is merely an example, and the configuration is not limited to this example. For example, the event information can be displayed using a popup window. Further, instead of displaying the event information on the display device 3, the event information may be presented by voice.

In the present embodiment, the balloon window B is displayed in the virtual execution environment 110b while following the mouse cursor C. However the display of the balloon window B becomes anchored in the virtual execution environment 110b when the user clicks the mouse (the input device 2). In a case where the display of the balloon window B is anchored in the virtual execution environment 110b due to the user selecting (clicking) one of the event information displayed in the balloon window B using the mouse, the event selection portion 28 in the virtual execution environment 110b receives an instruction to select that event information. The VM switching portion 29 in the virtual execution environment 110b instructs the hypervisor 12 to switch from the virtual execution environment currently used by the user to the virtual execution environment implemented by the virtual machine with the VM-ID contained in the event information that corresponds to the selection instruction.

For example, when the user instructs (clicks) to select the event information “VM-001: a message has been received ‘RE: oo’” displayed in the balloon window B with the mouse, the VM switching portion 29 in the virtual execution environment 110b instructs the supervisor 12 to switch from the virtual execution environment 110b currently used by the user to the virtual execution environment 110a corresponding to the selection instruction. The hypervisor 12 switches from the virtual execution environment 110b currently used by the user to the virtual execution environment 110a corresponding to the selection instruction. As a result, the virtual execution environment displayed on the display device 3 is switched from the virtual execution environment 110b to the virtual execution environment 110a. Further, when the virtual execution environment 110a is displayed on the display device 3, the user can check the details (e.g., the main text of the message) of the message reception event occurred in the IM by starting up the IM in the virtual execution environment 110a.

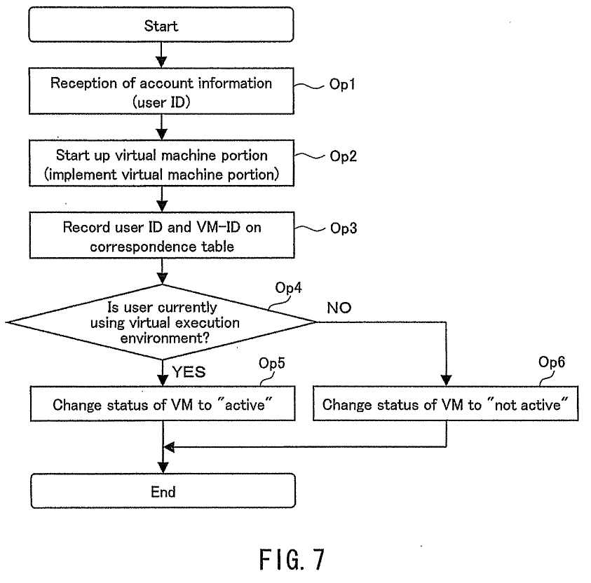

Next, operations of the information processing apparatus 1 according to the above configuration will be described with reference to FIGS. 7 to 10.

FIG. 7 is a flow chart illustrating an operation example of the information processing apparatus 1 when the user logged in thereto. As illustrated in FIG. 7, the information processing apparatus 1 receives account information (user ID) for logging in thereto from the user through the input device 2 (Op 1). Then, the information processing apparatus 1 receives an instruction to start up a virtual machine from the user through the input device 2. As a result, the virtual machine starts up and a virtual execution environment is implemented in the information processing apparatus 1 (Op 2).

Next, the hypervisor 12 of the information processing apparatus 1 brings the user ID received in Op 1 and the VM-ID of the virtual machine started up in Op 2 into correspondence, and records the correspondence on the correspondence table 13c (Op 3). Thereafter, the hypervisor 12 determines whether or not the user is currently using the virtual execution environment implemented in Op 2 (Op 4). Here, the phrase “the user is currently using the virtual execution environment” refers to a state in which the virtual execution environment is actually displayed on the display device 3 at present and the input device 2 is effective on the virtual execution environment displayed on the display device 3.

When the hypervisor 12 determines that the user is currently using the virtual execution environment implemented in Op 2 (YES in Op 4), it writes on the correspondence table 13 that the status of the VM is “active” (OP 5). In contrast, when the hypervisor 12 determines that the user is not currently using the virtual execution environment implemented in the Op 2 (NO in Op 4), it writes on the correspondence table 13 that the status of the VM is “not active” (OP 6). It is noted that every time the user newly starts up a virtual machine, the information processing apparatus 1 repeats the processes of Op 2 to Op 6 illustrated in FIG. 7.

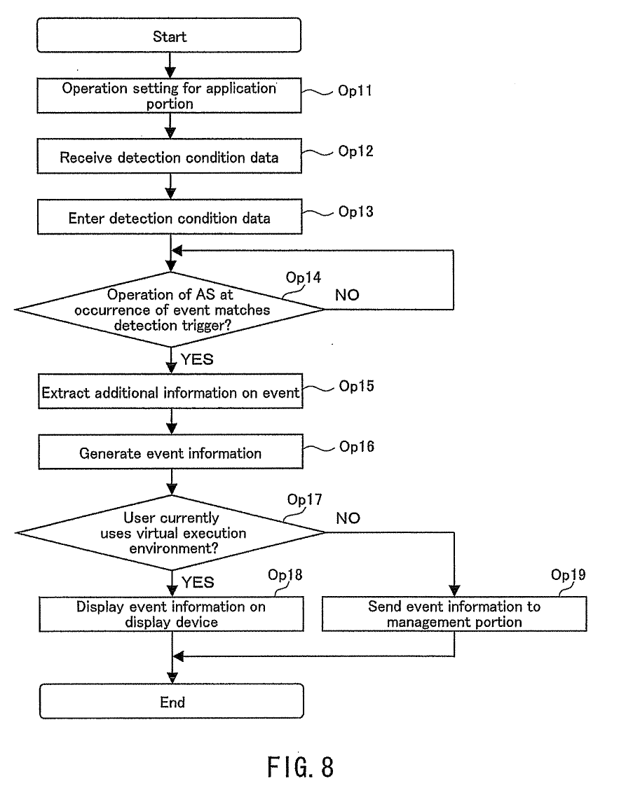

FIG. 8 is a flow chart illustrating an operation example of the information processing apparatus 1 when the event detection portion 24 detects an event in an application software program. As illustrated in FIG. 8, the information processing apparatus 1 receives an operation setting for the application portion 21 from the user through the input device 2 (Op 11). Here, the operation setting for the application portion 21 is, when the application software program is an IM for example, to set the IM to operate in such a manner that reproduction of the sound file 1 starts at the time of reception of a message by the IM.

And then, through the input device 2, the condition data entry portion 22 receives from the user detection condition data that containing: detection triggers each indicating an operation of an application software program at an occurrence of an event, and the events (Op 12). The condition data entry portion 22 enters the detection condition data received in Op 12 in the condition data table 23 (Op 13). As a result, as illustrated in FIG. 3 for example, the application software programs, the events, and the detection triggers are recorded on the condition data table 23 as the detection condition data.

Next, the event detection portion 24 determines, by monitoring the application portion 21, whether or not the operation of the application software program (“AS” in the figure) at the occurrence of an event matches any of the detection triggers recorded on the condition data table 23 (Op 14). When the event detection portion 24 determines that the operation of the application software program at the occurrence of the event matches with one of the detection triggers (YES in Op 14), it detects that the event recorded on the condition data table 23 while being corresponded with the detection trigger occurred in the application software program. That is, the event detection portion 24 detects the event occurred in the application software program. In this case, the event detection portion 24 extracts additional information on the event from the application software program in which the event occurred (Op 15). In contrast, when the event detection portion 24 determines that the operation of the application software program at the occurrence of the event does not match any of the detection triggers (NO in Op 14), it goes back to Op 14 and repeats the determination process of Op 14.

After Op 15, the event detection portion 24 generates event information on the detected event (Op 16). Here, the event information contains: the VM-ID of the virtual machine that implements the virtual execution environment in which the application software program with the occurred event operates, the application software program, the event, and the additional information on the event extracted in Op 15.

Then, the VM use determination portion 25 determines whether or not the user is currently using the virtual execution environment in which the application software program with the occurred event operates (Op 17). When the VM use determination portion 25 determines that the user is currently using the virtual execution environment in which the application software program with the occurred event operates (YES in Op 17), it outputs the event information generated in Op 16 to the display control portion 26. In this case, the display control portion 26 causes the display device 3 to display the event information outputted from the VM use determination portion 25 (Op 18). In contrast, when the VM use determination portion 25 determines that the user is not currently using the virtual execution environment in which the application software program with the occurred event operates (NO in Op 17), it outputs the event information generated in Op 16 to the event communication portion 27. In this case, the event communication portion 27 sends the event information outputted from the VM use determination portion 25 to the management portion 13 through the event channel 12a of the hypervisor 12 (Op 19).

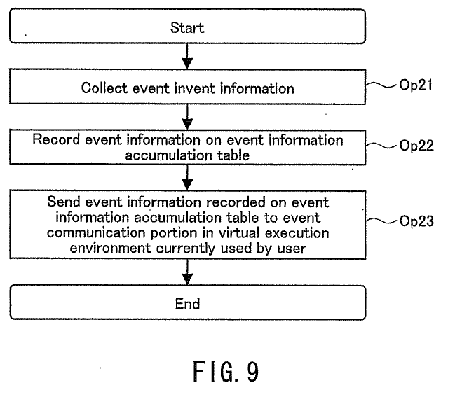

FIG. 9 is a flow chart illustrating an operation example of the information processing apparatus 1 when the event collection and distribution portion 13a collects the event information sent from the event communication portion 27 in each virtual execution environment. As illustrated in FIG. 9, the event collection and distribution portion 13a collects the event information (Op 19 in FIG. 8) sent from the event communication portion 27 in each virtual execution environment (Op 21). The event collection and distribution portion 13a records the event information collected in Op 21 on the event information accumulation table 13b (Op 22). As a result, the event information illustrated in FIG. 4, for example, is recorded on the event accumulation table 13b.

And then, through the event channel 12a of the hypervisor 12, the event collection and distribution 13a sends, with reference to the correspondence table 13c, the event information recorded on the event information accumulation table 13b to the event communication portion 27 in the virtual execution environment currently used by the user. In other words, the event collection and distribution portion 13a sends the event information recorded on the event information accumulation table 13b to the event communication portion 27 in the virtual execution environment implemented by the virtual machine with the VM-ID corresponding to “active” in the statuses of the VMs on the correspondence table 13c.

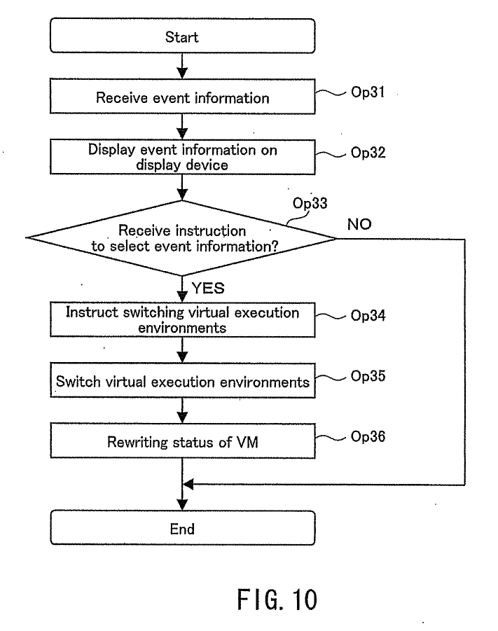

FIG. 10 is a flow chart illustrating an operation example of the information processing apparatus 1 when the event communication portion 27 in the virtual execution environment currently used by the user receives the event information from the event collection and distribution portion 13a. As illustrated in FIG. 10, the event communication portion 27 in the virtual execution environment currently used by the user receives the event information sent in Op 23 in FIG. 9 (Op 31). The display control portion 26 causes the display device 3 to display the event information received in Op 31 (Op 32). As a result, the event information as illustrated in, for example, FIG. 6 is displayed on the display device 3.

Here, the event selection portion 28 determines whether or not the user has given through the input device 2 an instruction to select the event information displayed on the display device 3 (Op 33). When the event selection portion 28 determines that the user has given the instruction to select the event information (YES in Op 33), it outputs the received selection instruction to the VM switching portion 29. In this case, the VM switching portion 29 instructs the hypervisor 12 to switch from the virtual execution environment currently used by the user to the virtual execution environment implemented by the virtual machine with the VM-ID contained in the event information corresponding to the selection instruction received by the event selection portion 28 (Op 34). In contrast, when the event selection portion 28 determines that the user has not given an instruction to select the event information (NO in Op 33), it ends the processes in FIG. 10.

After Op 34, the hypervisor 12 switches from the virtual execution environment in current use to the virtual execution environment corresponding to the instruction given in Op 34 (Op 35). And then, the hypervisor 12 rewrites the status of the VM recorded on the correspondence table 13c while being corresponded with the VM-ID of the virtual machine implementing the virtual execution environment to be newly displayed in Op 35 from “not active” to “active” (Op 36). Further, the hypervisor 12 rewrites the status of the VM recorded on the correspondence table 13c while being corresponded with the VM-ID of the virtual machine implementing the virtual execution environment switched in Op 35 from “active” to “not active” (Op 36).

As described above, according to the information processing apparatus 1 according to the present embodiment, the event detection portion 24 detects events that occurred in the virtual execution environments. When the event detection portion 24 detects events that occurred in the virtual execution environments not currently used by the user, the display control portion 26 presents in the virtual execution environment in current use event information concerning the event that occurred in the virtual execution environments. Therefore, without switching the virtual execution environments, the user can check in real time in the virtual execution environment actually displayed on the display device 3 at present that the events occurred in the virtual execution environments not displayed on the display device 3. As a result, it is possible to improve the convenience and productivity of the user.

### Embodiment 2

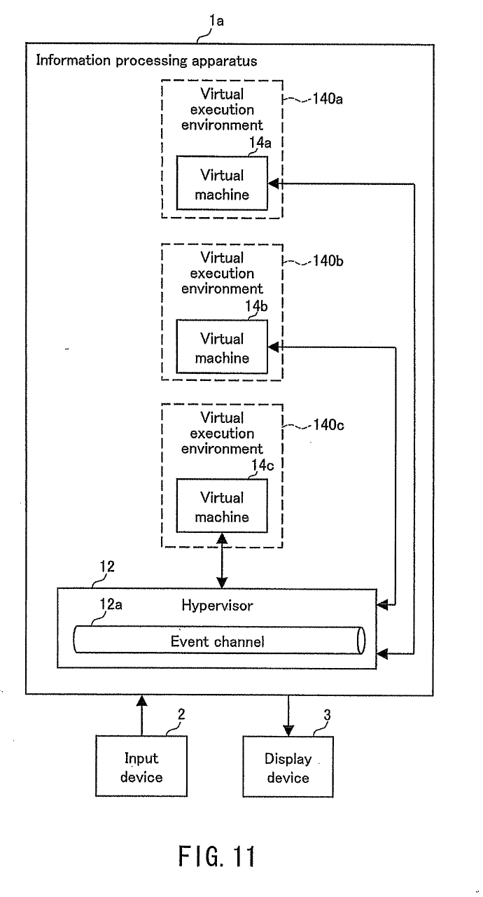

FIG. 11 is a block diagram illustrating a schematic configuration of an information processing apparatus 1a according to the present embodiment. That is, the information processing apparatus 1a according to the present embodiment does not include the management portion 13 illustrated in FIG. 1. Further, the information processing apparatus 1a according to the present embodiment includes virtual machines 14a to 14c in place of the virtual machines 11a to 11c illustrated in FIG. 1. It is noted that, in FIG. 11, components having the same function as those in FIG. 1 are denoted with the same reference numerals and the detailed description thereof will not be repeated.

Similarly to the virtual machines 11a to 11c, the virtual machines 14a to 14c are architectures or software that virtualize resources of the information processing apparatus 1a and then implement the virtualized information processing apparatus 1a. That is, the virtual machines 14a to 14c are respectively operated to implement virtual execution environments 140a to 140c in the information processing apparatus 1a.

It is noted that also in the present embodiment, a VM-ID is assigned to each of the virtualization machines 14a to 14c so as to uniquely identify the virtual machines. Specifically, the VM-ID “VM-001” is assigned to the virtual machine 14a, the VM-ID “VM-002” is assigned to the virtual machine 14b, and the VM-ID “VM-003” is assigned to the virtual machine 14c.

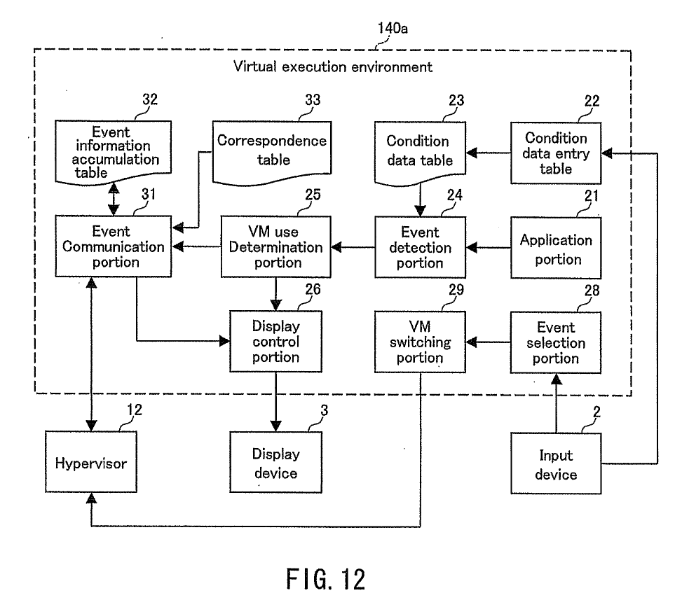

FIG. 12 is a diagram illustrating respective function blocks implemented in the virtual execution environment 140a according to the present embodiment. As illustrated in FIG. 12, the respective function blocks are implemented in the virtual execution environment 140a by the virtual machine 14a. That is, in the virtual execution environment 140a, an event communication portion 31 is implemented in place of the event communication portion 27 implemented in the virtual execution environment 110a illustrated in FIG. 2. Further, in the virtual execution environment 140a, an event information accumulation table 32 and a correspondence table 33 are implemented in addition to the respective function blocks implemented in the virtual execution environment 110a illustrated in FIG. 2. It is noted that, in FIG. 12, components having the same function as those in FIG. 2 are denoted with the same reference numerals and the detailed description thereof will not be repeated.

The event communication portion 31 sends event information outputted from the VM use determination portion 25 to the event communication portions 31 in the virtual execution environment 140b and the virtual execution environment 140c through the event channel 12a of the hypervisor 12. That is, the event communication portion 31 broadcasts the event information outputted from the VM use determination portion 25 to each of the event communication portions 31 in the virtual execution environments 140b and 140c. For example, when another user is using the virtual execution environment 140c between the virtual execution environments 140b and 140c, the event communication portion 31 sends the event information outputted from the VM use determination portion 25 only to the event communication portion 31 in the virtual execution environment 140b. That is, in order to ensure that the event information is sent only to the event communication portions in the virtual execution environments used by the same user, the event communication portion 31 preferably puts an user ID in the event information that it sends.

Further, the event communication portion 31 receives event information sent from the event communication portions 31 in other virtual execution environments through the event channel 12a of the hypervisor 12. The event communication portion 31 records the received event information on the event information accumulation table 32. Here, the event information accumulation table 32 has a data structure similar to that of the event information accumulation table 13b illustrated in FIG. 4.

On the correspondence table 33, correspondence data indicating the correspondence between a user ID for uniquely identifying a user and the VM-ID assigned to the virtual machine that implements the virtual execution environment currently used by the user is recorded. Here, the correspondence table 33 has a data structure similar to that of the correspondence table 13c illustrated in FIG. 5.

With reference to the correspondence table 33, the event communication portion 31 determines whether or not the status of the virtual machine 14a that implements the virtual execution environment (the virtual execution environment 140a in FIG. 12) in which the event communication portion is implemented is “active”. When the status of the virtual machine is “active”, the event communication portion 31 reads out the event information recorded on the event information accumulation table 32, and outputs the read-out event information to the display control portion 26. The display control portion 26 causes the display device 3 to display the event information outputted from the event communication portion 31.

As described above, according to the information processing apparatus 1a according to the present embodiment, the information processing apparatus 1a does not need to include a control portion in comparison with the information processing apparatus 1 according to Embodiment 1. That is, in the information processing apparatus 1a according to the present embodiment, event information does not need to be collected from the event communication portion implemented in each virtual execution environment. Therefore, functions to be included in the information processing apparatus 1a according to the present embodiment can be simplified in comparison with the information processing apparatus 1 according to Embodiment 1.

### Embodiment 3

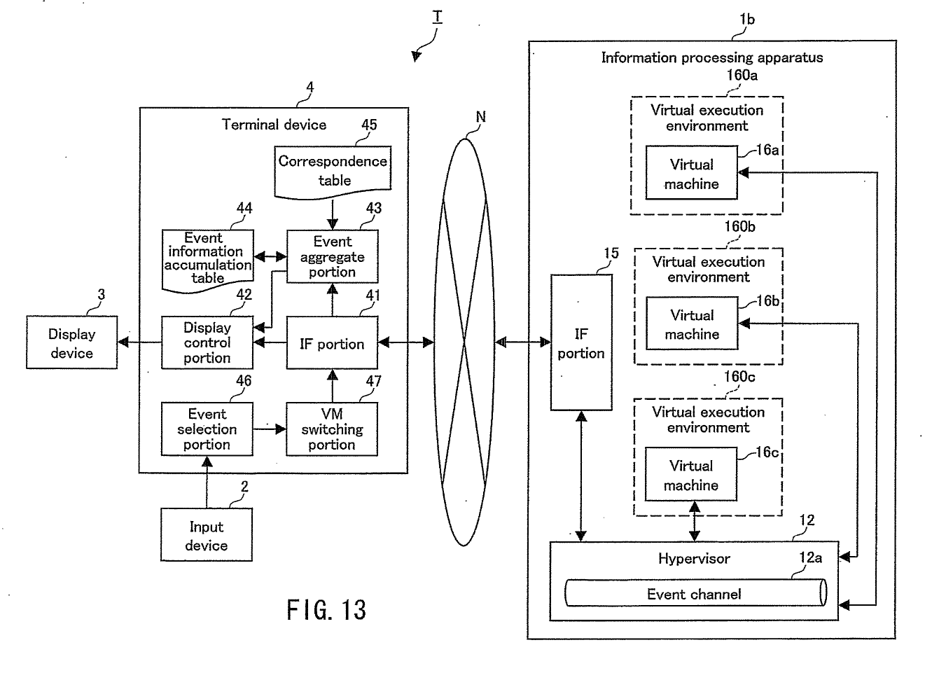

FIG. 13 is a block diagram illustrating a schematic configuration of a communication system T according to the present embodiment. That is, the communication system T according to the present embodiment includes an information processing apparatus 1b and a terminal device 4. Here, the information processing apparatus 1b and the terminal device 4 are connected to a network N. The network N is, for example, the Internet and the information processing apparatus 1b and the terminal device 4 can communicate with each other using a given protocol such as TCP/IP, UDP/IP, or the like. It is noted that the network N may be, in place of the Internet, Ethernet (registered trademark), a home network, a wireless LAN, or the like. Further, the terminal device 4 illustrated in FIG. 13 is connected to the input device 2 and the display device 3. It is noted that, in FIG. 13, components having the same function as those in FIG. 1 are denoted with the same reference numerals and the detailed description thereof will not be repeated.

Although the number of each of the information processing apparatus 1b and the terminal device 4 illustrated in FIG. 13 is 1, the number of the information processing apparatus 1b and the terminal device 4 that form the communication system T can be determined arbitrarily. Further, a plurality of the terminal devices 4 may be provided per the information processing apparatus 1b. Furthermore, a web server, a proxy server, a DNS server, a DHCP server, and the like may be present in the communication system T.

As illustrated in FIG. 13, the information processing apparatus 1b according to the present embodiment includes an interface portion (an IF portion in the figure) 15. Further, the information processing apparatus 1b according to the present embodiment includes virtual machines 16a to 16c in place of the virtual machines 11a to 11c illustrated in FIG. 1. It is noted that the information processing apparatus 1b according to the present embodiment does not include the management portion 13 illustrated in FIG. 1.

The interface portion 15 intermediates a data exchange between the terminal device 4 and the hypervisor 12 of the information processing apparatus 1b through the network N.

Similarly to the virtual machines 11a to 11c illustrated in FIG. 1, the virtual machines 16a to 16c are architectures or software that virtualize resources of the information processing apparatus 1b and then implement the virtualized information processing apparatus 1a. That is, the virtual machines 16a to 16c are respectively operated to implement virtual execution environments 160a to 160c in the information processing apparatus 1b.

It is noted that also in the present embodiment, a VM-ID is assigned to each of the virtualization machines 16a to 16c so as to uniquely identify the virtual machines. Specifically, the VM-ID “VM-001” is assigned to the virtual machine 16a, the VM-ID “VM-002” is assigned to the virtual machine 16b, and the VM-ID “VM-003” is assigned to the virtual machine 16c.

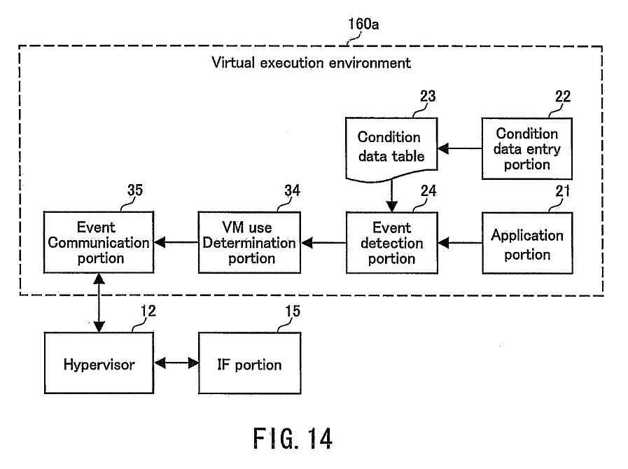

FIG. 14 is a diagram illustrating respective function blocks implemented in the virtual execution environment 160a according to the present embodiment. As illustrated in FIG. 14, the respective function blocks are implemented in the virtual execution environment 160a by the virtual machine 16a. That is, in the virtual execution environment 160a, a VM use determination portion 34 and an event communication portion 35 are implemented in place of the VM use determination portion 25 and the event communication portion 27 that are implemented in the virtual execution environment 110a illustrated in FIG. 2. Further, in the virtual execution environment 160a, the respective function blocks of the display control portion 26, the event selection portion 28, and the VM switching portion 29 that are implemented in the virtual execution environment 110a illustrated in FIG. 2 are not implemented. It is noted that, in FIG. 14, components having the same function as those in FIG. 2 are denoted with the same reference numerals and the detailed description thereof will not be repeated.

Similarly to the VM use determination portion 25 illustrated in FIG. 2, when event information is outputted from the event detection portion 24, the VM use determination portion 34 determines whether or not the user is currently using the virtual execution environment (the virtual execution environment 160a in FIG. 14) in which the VM use determination portion 34 is implemented. That is, the VM use determination portion 34 determines whether or not the user is currently using the virtual execution environment in which an application software program with an occurred event operates. Here, the phrase “the user is currently using the virtual execution environment” refers to a state in which the virtual execution environment is actually displayed on the display device 3 at present through the network N, and the input device 2 is effective on the virtual execution environment displayed on the display device 3.

When the VM use determination portion 34 determines that the user is currently using the virtual execution environment in which the application software program with the occurred event operates, it inserts into the event information outputted from the event detection portion 24 usage status information indicating that the user is currently using the virtual execution environment. In contrast, when the VM use determination portion 34 determines that the user is not currently using the virtual execution environment in which the application software program with the occurred event operates, it inserts into the event information outputted from the event detection portion 24 usage status information indicating that the user is not currently using the virtual execution environment. The VM use determination portion 34 outputs to the event communication portion 35 the event information into which the usage status information is inserted.

The event communication portion 35 outputs the event information outputted from the VM use determination portion 34 to the interface portion 15 through the event channel 12a of the hypervisor 12. The interface portion 15 sends the event information outputted from the event communication portion 35 to the terminal device 4 through the network N.

The terminal device 4 includes an interface portion 41, a display control portion 42, an event aggregate portion 43, an event information accumulation table 44, a correspondence table 45, an event selection portion 46, and a VM switching portion 47.

Here, each of the information processing apparatus 1b, the display control portion 42, and the event selection portion 46 is one embodiment of the event detection system according to the present invention.

The interface portion 41 receives the event information sent from the information processing apparatus 1b through the network N. Here, when the event information sent from the information processing apparatus 1b contains the usage status information indicating that the user is currently using the virtual execution environment, the interface portion 41 outputs the event information sent from the information processing apparatus 1b to the display control portion 42. In this case, the display control portion 42 causes the display device 3 to display the event information outputted from the interface portion 41. As a result, the user can check in the virtual execution environment he or she currently uses that the event occurred in the application software program. In contrast, when the event information sent from the information processing apparatus 1b contains the usage status information indicating that the user is not currently using the virtual execution environment, the interface portion 41 outputs the event information sent from the information processing apparatus 1b to the event aggregate portion 43. In this case, the event aggregate portion 43 records the event information outputted from the interface portion 41 on the event information accumulation table 44. Here, the event information accumulation table 44 has a data structure similar to that of the event information accumulation table 13b illustrated in FIG. 4.

On the correspondence table 45, correspondence data indicating the correspondence between a user ID for uniquely identifying a user and the VM-ID of the virtual machine that implements the virtual execution environment currently used by the user is recorded. Here, the correspondence table 45 has a data structure similar to that of the correspondence table 13c illustrated in FIG. 5.

The event aggregate portion 43 instructs the display control portion 42 to display the event information recorded on the event information accumulation table 44 in the virtual execution environment implemented by the virtual machine with the VM-ID corresponding to “active” in the statuses of the VMs on the correspondence table 45. Thus, the event aggregate portion 45 reads out the event information recorded on the event information accumulation table 44, and outputs the read-out event information to the display control portion 42. The display control portion 42 causes the display device 3 to display the event information outputted from the event aggregate portion 45. Thus, without switching the virtual execution environments, the user can check in real time in the virtual execution environment he or she currently uses that the events occurred in the virtual execution environments not currently used by the user.

The event selection portion 46 receives an instruction to select the event information displayed on the display device 3 from the user through the input device 2. The event selection portion 46 outputs the received selection instruction to the VM switching portion 47.

The VM switching portion 47 instructs the hypervisor 12 of the information processing apparatus 1b through the interface portion 41 and the network N to switch from the virtual execution environment currently used by the user to the virtual execution environment implemented by the virtual machine with the VM-ID contained in the event information corresponding to the selection instruction received by the event selection portion 46.

As described above, according to the communication system T according to the present embodiment, similarly to Embodiments 1 and 2, without switching the virtual execution environments, the user can check in the virtual execution environment that is actually displayed on the display device 3 at the present that events occurred in the virtual execution environments that are not displayed on the display device 3 even when the information processing apparatus 1b and the terminal device 4 are connected to each other through the network N.

As described above, the present invention is useful as an event detection system, an event detection method and a program that can improve the convenience and productivity of a user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. An event detection computer system accessible to a display device, comprising:
a plurality of virtual machines that respectively implement virtual execution environments;
an event detection portion that detects an event occurred in the virtual execution environments; and
an event presentation portion that presents, when an event occurred in the virtual execution environment not displayed on the display device being detected by the event detection portion, event information concerning the event occurred in the virtual execution environment in a virtual execution environment currently displayed on the display device.

2. The event detection computer system according to claim 1,
wherein the event detection computer system is further accessible to an input device,
the event information includes at least the event that occurred in the virtual execution environment and identification data for identifying the virtual machine implementing the virtual execution environment in which the event occurred, and
the event detection computer system further comprises:
an event selection portion that receives an instruction from a user through the input device to select the event information presented in the virtual execution environment currently displayed on the display device; and
a virtual execution environment switching portion that switches from the virtual execution environment currently displayed on the display device to the virtual execution environment implemented by the virtual machine indicated by the identification data of the event information corresponding to the selection instruction received by the event selection portion.

3. The event detection computer system according to claim 1,
wherein the event detection computer system is further accessible to an input device,
the event detection computer system further comprises a condition data entry portion that receives, from the user through the input device, detection condition data that associates a detection trigger indicting an action at an occurrence of an event in the virtual execution environment with the event, and enters the condition data in a condition data recording portion, and
when the action at the occurrence of the event in the virtual execution environment matches the detection trigger indicated by the detection condition data entered in the condition data recording portion, the event detection portion detects that the event associated with the detection trigger occurred in the virtual execution environment.

4. The event detection computer system according to claim 3,
wherein the action at the occurrence of the event in the virtual execution environment is a start of reproduction of an audio file or display of a pop-up window.

5. An event detection method executed by an event detection computer system accessible to a display device, the method comprising:
implementing virtual execution environments respectively by a plurality of virtual machines;
detecting an event occurred in the virtual execution environments; and
presenting, when an event occurred in the virtual execution environment not displayed on the display device being detected in the detection, event information concerning the event occurred in the virtual execution environment in a virtual execution environment currently displayed on the display device.

6. A computer program product stored in a computer readable recording medium containing instructions for execution by a computer, which when executed by the computer, cause the computer to perform:
a virtual execution environment implementation process for implementing virtual execution environments;
an event detection process for detecting an event occurred in the virtual execution environments; and
an event presentation process for presenting, when an event occurred in the virtual execution environment not displayed on the display device being detected in the event detection process, event information concerning the event occurred in the virtual execution environment in a virtual execution environment currently displayed on the display device.
